(19) United States
(12) Patent Application Publication
(10) Pub. No.: US 2025/0056489 A1
(43) Pub. Date: Feb. 13, 2025

(54) TERMINAL POSITIONING METHOD AND APPARATUS, COLLISION WARNING SYSTEM, AND ELECTRONIC DEVICE

(71) Applicant: Tencent Technology (Shenzhen) Company Limited, Shenzhen (CN)

(72) Inventor: Yipeng ZHANG, Shenzhen (CN)

(73) Assignee: Tencent Technology (Shenzhen) Company Limited, Shenzhen (CN)

(21) Appl. No.: 18/933,185

(22) Filed: Oct. 31, 2024

Related U.S. Application Data
(63) Continuation of application No. PCT/CN2023/086036, filed on Apr. 3, 2023.

(30) Foreign Application Priority Data
Jul. 7, 2022 (CN) 202210795063.5

(51) Int. Cl. H04W 64/00; H04W 4/40; H04W 92/18

(52) U.S. Cl. CPC H04W 64/00; H04W 4/40; H04W 92/18

(57) ABSTRACT

A terminal positioning method, applied to a vehicle-to-everything terminal, includes: receiving a PC5 message via a PC5 communication interface; and based on determining the PC5 message was transmitted by a target road side unit, activating positioning and performing positioning in a movement process in different positioning modes based on a current terminal position, wherein a positioning accuracy of a positioning mode is increased as a distance between the current terminal position and a collision-prone area decreases, and wherein the positioning accuracy is decreased as the distance between the current terminal position and the collision-prone area increases.

### CROSS-REFERENCE TO RELATED APPLICATIONS

This application is a continuation application of International Application No. PCT/CN2023/086036 filed on Apr. 3, 2023, which claims priority to Chinese Patent Application No. 202210795063.5 filed with the China National Intellectual Property Administration on Jul. 7, 2022, the disclosures of each being incorporated herein by reference in their entireties.

### FIELD

The disclosure relates to the field of intelligent traffic technologies, and in particular, to a terminal positioning method, a terminal positioning apparatus, a collision warning system, a computer-readable medium, and an electronic device.

### BACKGROUND

In a scenario, such as an intersection, a T-junction, or a parking lot, shared by a pedestrian, a non-motorized vehicle, and a motor vehicle, a traffic accident may occur as a result of jaywalking, running a red light, a blind spot, or the like. To ensure traffic safety, with rapid development of a vehicle-to-everything technology, a plurality of collision warning technologies emerge.

Currently used positioning technology has difficulty balancing positioning accuracy and power consumption, especially for a terminal device without a charging condition, such as a terminal device used by a pedestrian, a non-motor vehicle driver, a special transportation (for example, a wheelchair) user, or the like. A battery of the terminal device may be unable to support extended battery life. If a low-accuracy positioning method is used, the battery life may be increased to an extent, but positioning accuracy may be sacrificed, and accurate collision warning may not be implemented. In addition, during positioning, receiving a positioning signal through a cellular network depends on the quality of a cellular network signal, and reception may be unstable, also resulting in reduction of positioning accuracy.

### SUMMARY

Provided are a terminal positioning method, a terminal positioning apparatus, a collision warning system, a computer-readable medium, and an electronic device, which can take into account accurate positioning and battery life in a terminal.

According to some embodiments, a terminal positioning method, applied to a vehicle-to-everything terminal, includes: receiving a PC5 message via a PC5 communication interface; and based on determining the PC5 message was transmitted by a target road side unit, activating positioning, and performing positioning in a movement process in different positioning modes based on a current terminal position, wherein a positioning accuracy of a positioning mode is increased as a distance between the current terminal position and a collision-prone area decreases, and wherein the positioning accuracy is decreased as the distance between the current terminal position and the collision-prone area increases.

According to some embodiments, a terminal positioning apparatus, configured in a vehicle-to-everything terminal, includes: a PC5 communication interface; at least one memory configured to store computer program code; at least one processor configured to read the program code and operate as instructed by the program code, the program code including: receiving code configured to cause at least one of the at least one processor to receive a PC5 message via the PC5 communication interface; and positioning code configured to cause at least one of the at least one processor to: determine whether the PC5 message was transmitted by a target road side unit; and based on the PC5 message being transmitted by the target road side unit, activate positioning, and perform positioning in a movement process in different positioning modes based on a current terminal position, wherein a positioning accuracy of a positioning mode is increased as a distance between the current terminal position and a collision-prone area decreases, and wherein the positioning accuracy is decreased as the distance between the current terminal position and the collision-prone area increases.

According to some embodiments, a non-transitory computer-readable storage medium, storing computer code which, when executed by at least one processor, causes the at least one processor to at least: receive a PC5 message via a PC5 communication interface; determine whether the PC5 message was transmitted by a target road side unit; and based on the PC5 message being transmitted by the target road side unit, activate positioning, and perform positioning in a movement process in different positioning modes based on a current terminal position, wherein a positioning accuracy of a positioning mode is increased as a distance between the current terminal position and a collision-prone area decreases, and wherein the positioning accuracy is decreased as the distance between the current terminal position and the collision-prone area increases.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 exemplarily shows a block diagram of an architecture of a collision warning system according to some embodiments.

FIG. 2 exemplarily shows a schematic flowchart of a terminal positioning method according to some embodiments.

FIG. 3 exemplarily shows a schematic structural diagram of a vehicle-to-everything dedicated pedestrian terminal according to some embodiments.

FIG. 4 exemplarily shows a schematic flowchart of determining that a received PC5 message is a message transmitted by a target road side unit according to some embodiments.

FIG. 5 exemplarily shows a schematic diagram of an interface in which a signal coverage area of a target road side unit located at an intersection is divided into a plurality of areas according to some embodiments.

FIG. 6 exemplarily shows a schematic diagram of a division interface of an area with a bandwidth area according to some embodiments.

FIG. 7 exemplarily shows a schematic flowchart of switching a positioning mode according to some embodiments.

FIG. 8 exemplarily shows a schematic flowchart of switching a positioning mode according to some embodiments.

FIG. 9A to FIG. 9F exemplarily show schematic diagrams of changing interfaces of an area in which a vehicle-to-everything terminal is located and a positioning mode used during movement according to some embodiments.

FIG. 10 exemplarily shows a block diagram of a structure of a terminal positioning apparatus according to some embodiments.

FIG. 11 exemplarily shows a block diagram of a structure of a computer system of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments are described with reference to the accompanying drawings. However, some embodiments may be implemented in various forms and are not limited to the examples described herein. Conversely, some embodiments are provided to convey the ideas of the disclosure to a person skilled in the art.

In addition, the described features, structures, or characteristics may be combined in one or more embodiments in any appropriate manner. Information is provided for understanding the disclosure. However, a person skilled in the art is to be aware of that, some embodiments may be implemented without one or more of the details, or other methods, units, apparatuses, or operations may be adopted.

The block diagrams shown in the accompanying drawings may be functional entities according to some embodiments and may or may not correspond to physically independent entities. Such functional entities may be implemented in the form of software, or implemented in one or more hardware modules or integrated circuits, or implemented in different networks and/or processor apparatuses and/or microcontroller apparatuses.

The flowcharts shown in the accompanying drawings are examples according to some embodiments and are not necessarily performed in the described orders. Some operations may also be further divided, and some operations may be combined or partially combined.

In the related art in this field, to reduce positioning power consumption, positioning is performed by using a low-power consumption mobile base station global system for mobile communication (GSM) and a Bluetooth sensor. Specifically, the mobile base station GSM queries a nearby base station, to calculate a current position of a user, and then a mobile terminal periodically turns on the Bluetooth sensor, to scan a surrounding device and detect whether there is another Bluetooth device in the surroundings. If there is another Bluetooth device, a matching mechanism is started, and an available Bluetooth device is automatically connected, and previous positioning information of both sides is respectively transmitted through Bluetooth, to compare positioning accuracy of the mobile terminal and that of the Bluetooth device according to the positioning information. If the positioning accuracy of the Bluetooth device is higher than that of the mobile terminal, the mobile terminal updates the positioning information. Otherwise, the positioning information of the mobile terminal remains unchanged.

Although a low-power consumption positioning method is implemented in a manner based on cellular network+Bluetooth in the related art, the method is applicable to an indoor scenario. For an outdoor traffic scenario, deploying the Bluetooth device is costly and is to bring an additional maintenance problem. In addition, a problem such as low positioning accuracy, signal instability, or inability to receive positioning information caused by incomplete cellular network coverage exists in cellular network positioning.

High-accuracy positioning modes include a global navigation satellite system (GNSS) positioning mode, a GNSS-based enhanced positioning mode, and the like.

A GNSS includes a global positioning system (GPS), a GLONASS, a Galileo, and a Beidou. Positioning accuracy of a civilian GNSS device may be about 10 meters. Compared with a cellular positioning mode, the positioning accuracy is greatly improved, but power consumption of the GNSS positioning mode is larger. For example, power consumption of a GPS module and a Beidou module is about 160 mW, which is second only to those of a screen and a cellular communication module in a smart terminal. According to research, a smart phone may provide a continuous GPS positioning service for only 5 hours to 6 hours, and a smart watch may provide the GPS positioning service for only 2 hours to 3 hours, which is difficult to satisfy a long-term positioning requirement of the user. The GNSS-based enhanced positioning mode may be a real-time kinematic (RTK) differential system-based GNSS enhanced positioning mode. Positioning accuracy thereof may reach a decimeter level or even a centimeter level. However, power consumption of a RTK positioning module is large. Power consumption of a RTK commercial module may reach 1 W. Power consumption of a RTK module known as “low power consumption” also reaches 500 mW. If a RTK positioning function is continuously turned on, continuous use time of the smart terminal is to be difficult to support normal use. In addition, RTK positioning uses cellular communication for obtaining a differential correction signal. For a small and medium-sized pedestrian terminal in the vehicle-to-everything system, introduction of a cellular communication module may consume additional power. In addition, even on a terminal with a cellular communication capability, the differential correction signal may also not be reliably received due to unstable cellular communication or incomplete coverage. RTK positioning capability may therefore be reduced or unusable.

For the problems existing in the related art, some embodiments provide a terminal positioning method. Based on the terminal positioning method, collision warning with high accuracy and low power consumption in a scenario such as a vehicle-to-everything pedestrian protection scenario, a vehicle-to-everything non-motor vehicle driver protection scenario, or a vehicle-to-everything special vehicle user protection scenario may be implemented.

Before describing the technical solution in some embodiments in detail, technical terms that may be involved in some embodiments are explained and described first.
(1) Vehicle-to-everything: A concept of vehicle-to-everything originates from an Internet of Things or a vehicle Internet of Things, in which a vehicle during traveling is used as an information sensing object, to implement a network connection between the vehicle and things such as another vehicle, a person, a road, or a service platform, with assistance of a new-generation information communication technology, to improve an entire intelligent driving level of the vehicle, provide a safe, comfortable, intelligent, and efficient driving feeling and traffic service for the user, improve traffic operation efficiency, and improve an intelligence level of a social traffic service.
(2) C-V2X: Cellular vehicle-to-everything is defined by a 3rd generation partnership project (3GPP) organization and is based on a cellular modem technology. The C-V2X is a vehicle wireless communication technology formed based on evolution of a cellular network communication technology such as a 3rd-generation mobile communication technology (3G)/4th-generation mobile communication technology (4G)/5th-generation mobile communication technology (5G). The C-V2X is a communication technology based on a 3GPP global unified standard, including LTE-V2X and 5G-V2X. From a perspective of technological evolution, the LTE-V2X supports smooth evolution to the 5G-V2X. The V2X includes vehicle to infrastructure (V2I), vehicle to network (V2N), vehicle to pedestrian (V2P), and vehicle to vehicle (V2V).
(3) PC5: It is a communication interface of the C-V2X, and is a short-range direct communication interface among a vehicle, a person, and a road.
(4) Road side unit (RSU): It is a device deployed on a road side in a vehicle-to-everything system, and belongs to a type of I in the V2I. The RSU is connected to a road side device (a road side sensing device, a traffic light, an electronic sign, or the like) and a multi-access/mobile edge computing (MEC) platform or a cloud platform through the cellular network or in a wired manner, to obtain various types of data such as traffic, vehicle infrastructure cooperation, and management. In addition, the RSU broadcasts obtained information to the surroundings through PC5 direct communication. Generally, a communication coverage range of the RSU is 300 meters to 500 meters without obstruction.

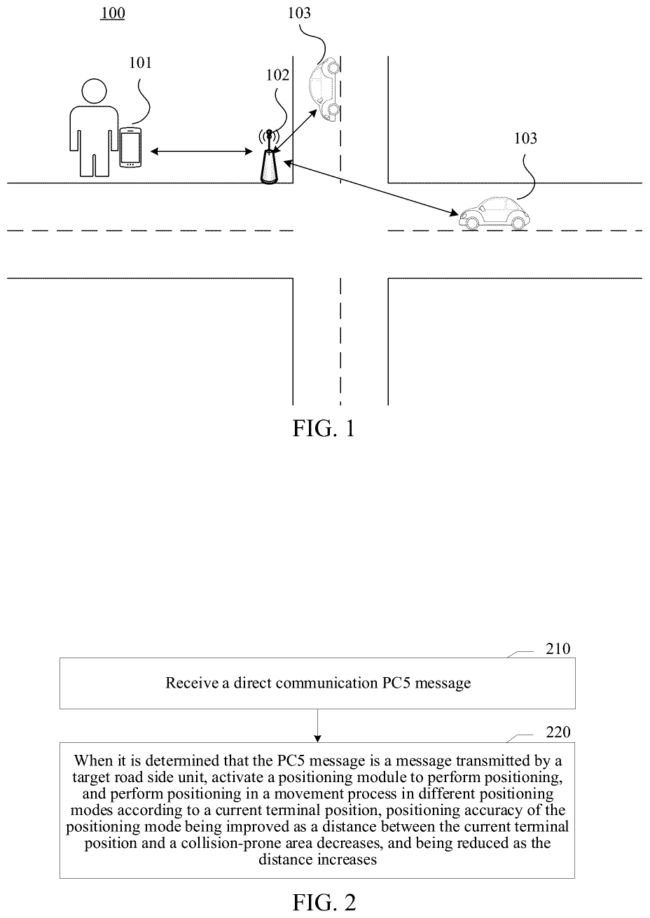

After the technical terms that may be involved in some embodiments are introduced, an exemplary system architecture is described below with reference to FIG. 1.

FIG. 1 shows a block diagram of an architecture of a collision warning system to according to some embodiments.

As shown in FIG. 1, a collision warning system 100 may include a vehicle-to-everything terminal 101, a road side unit 102, a vehicle 103, and a network.

The vehicle-to-everything terminal 101 is a terminal device connected to the road side unit 102 and the vehicle 103 through a direct communication PC5 interface. The terminal device may be a terminal device carried by a pedestrian, a non-motor vehicle driver, or a special vehicle (wheel) user, and may be a smart phone, a tablet computer, a portable computer, a smart bracelet, a smart watch, a pair of smart glasses, or the like. After being turned on, the vehicle-to-everything terminal 101 may receive PC5 messages transmitted by other terminal devices in the road side unit 102, the vehicle 103, and a vehicle-to-everything system through PC5 communication interfaces, and perform positioning according to the received PC5 message. When performing positioning according to the received PC5 message, the vehicle-to-everything terminal 101 parses the PC5 message, and determines whether the message is a PC5 message transmitted by a target road side unit. If it is determined that the message is the PC5 message transmitted by the target road side unit, the vehicle-to-everything terminal activates a positioning module to perform positioning, and performs positioning in different positioning modes according to a current terminal position, to obtain positioning information. Finally, the vehicle-to-everything terminal 101 may transmit the positioning information to the vehicle 103 through the PC5 communication interface, so that the vehicle 103 performs collision warning according to the positioning information and a current vehicle position of the vehicle.

The road side unit 102 can receive information broadcast by the vehicle-to-everything terminal 101 and the vehicle 103 that are within a signal coverage range, and broadcast the received information to another vehicle-to-everything terminal 101 and another vehicle 103 that are within the signal coverage range. For example, the road side unit 102 may broadcast PC5 messages to the vehicle-to-everything terminal 101 and the vehicle 103 that are within the signal coverage range through the PC5 communication interfaces, and receive PC5 messages broadcast by the vehicle-to-everything terminal 101 and the vehicle 103 through the PC5 communication interfaces.

The vehicle 103 may be any type of vehicle running on a road, and may receive positioning information broadcast by the vehicle-to-everything terminal 101 through the PC5 communication interface, determine a relative position between the vehicle and the vehicle-to-everything terminal according to the positioning information and the current vehicle position of the vehicle, and determine whether collision may occur between the vehicle and the vehicle-to-everything terminal. When it is determined that the collision may occur, warning information is generated, so that the vehicle avoids a user of the vehicle-to-everything terminal 101 according to the warning information.

In the collision warning system provided in some embodiments, the network may be a communication medium of each type of connection type that can provide communication links between the vehicle-to-everything terminal 101 and the road side unit 102, between the vehicle-to-everything terminal 101 and the vehicle 103, and between the road side unit 102 and the vehicle 103, and may be, for example, a wired communication link or a wireless communication link.

The system architecture in some embodiments may include any number of vehicle-to-everything terminals 101, road side units 102, vehicles 103, and networks.

Some embodiments relate to vehicle-to-everything technologies, an intelligent traffic system, and an intelligent vehicle infrastructure cooperative system.

The intelligent traffic system (ITS) is also referred to as an intelligent transportation system, and applies advanced science and technologies (an information technology, a computer technology, a data communication technology, a sensor technology, an electronic control technology, an automatic control theory, operational research, an artificial intelligence technology, and the like) to transportation, service control, and vehicle manufacturing, to strengthen a connection among the vehicle, the road, and the user, thereby forming an integrated transportation system for safety assurance, efficiency improvement, environmental improvement, and energy saving.

The intelligent vehicle infrastructure cooperative system (IVICS), referred to as a vehicle infrastructure cooperative system for short, is a development direction of the intelligent traffic system (ITS). The vehicle infrastructure cooperative system uses advanced wireless communication and new-generation Internet technologies and the like to implement interaction of vehicle-to-vehicle dynamic real-time information and vehicle-to-road dynamic real-time information, and perform active vehicle safety control and road collaboration management based on acquisition and integration of full-time-and-space dynamic traffic information, to fully implement effective cooperation of people, vehicles and roads, ensure traffic safety, and improve traffic efficiency, thereby forming a safe, efficient, and environmentally friendly road traffic system.

Some embodiments relate to a cloud technology, a cloud application, Internet of Things, and cloud Internet of Things.

The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, may form a resource pool, and may be flexible and convenient. A background service of a technical network system may use a large amount of computing and storage resources, such as video websites, image websites, and more portal websites. As the Internet industry is highly developed and applied, each article may have its own identifier in the future and may be transmitted to a background system for logical processing. Data at different levels is separately processed, and data in various industries may have strong system support, which may be implemented through cloud computing.

The Internet of Things (IOT) refers to acquiring, in real time through various devices and technologies such as various information sensors, a radio frequency identification technology, a global positioning system, an infrared sensor, and a laser scanner, any object or process that has a connection or interaction; acquiring various information such as sound, light, heat, electricity, mechanics, chemistry, biology, a position, and the like; implementing ubiquitous connection between a thing and a thing, and between a thing and a person over a network; and implementing intelligent sensing, identification, and management of the object and the process. The Internet of Things is an information carrier based on the Internet, a telecommunication network, and the like, and allows all ordinary physical objects that can be independently addressed to form an interconnected network.

The cloud Internet of Things (Cloud IOT) aims to connect information sensed by a sensing device and instructions received by the sensing device in Internet of Things to the Internet to implement networking and implement massive data storage and operations through a cloud computation technology. Because a characteristic of the Internet of Things is that things are connected to each other, a current operating status of each “object” is sensed in real time, and a large amount of data information is to be generated in this process, how to summarize such information and how to filter out information from the massive information to make a decision and support for subsequent development have become key problems affecting development of the Internet of Things. Therefore, the cloud Internet of Things based on cloud computation and cloud storage technologies becomes a strong support for the Internet of Things technology and application.

Some embodiments such as a terminal positioning method, a terminal positioning apparatus, a computer-readable medium, and an electronic device are described in below.

FIG. 2 exemplarily shows a schematic flowchart of operations of a terminal positioning method according to some embodiments. The terminal positioning method may be performed by a vehicle-to-everything terminal, as shown in the vehicle-to-everything terminal 101 in FIG. 1. As shown in FIG. 2, the terminal positioning method in some embodiments may include the following operations.

210: Receive a direct communication PC5 message.

220: When it is determined that the PC5 message is a message transmitted by a target road side unit, activate a positioning module to perform positioning, and perform positioning in a movement process in different positioning modes according to a current terminal position,
positioning accuracy of the positioning mode being improved as a distance between the current terminal position and a collision-prone area decreases, and being reduced as the distance increases.

In the terminal positioning method provided in some embodiments, during running, a vehicle-to-everything terminal receives a PC5 message transmitted by each type of terminal in a vehicle-to-everything system, and determines, by parsing the PC5 message, whether the PC5 message is a message transmitted by a target road side unit. When it is determined that the PC5 message is transmitted by the target road side unit, the vehicle-to-everything terminal activates a positioning module to perform positioning, and performs positioning in a movement process in different positioning modes according to a current terminal position, to obtain positioning information. Positioning may be triggered based on receiving the PC5 message transmitted by the target road side unit. There may be no need to turn on the positioning module out of a signal coverage range of the target road side unit if the PC5 message is detected, and power loss of the vehicle-to-everything terminal may therefore be reduced. In addition, during positioning, positioning is performed in different positioning modes according to different positions of the vehicle-to-everything terminal, and positioning accuracy of the positioning mode is improved as a distance between the vehicle-to-everything terminal and a collision-prone area decreases, and is reduced as the distance increases, which effectively balance a relationship between the positioning accuracy and power consumption. That is to say, high-accuracy positioning is ensured, and the power consumption is also reduced, so that battery life of the vehicle-to-everything terminal is extended.

Some embodiments are described in below by using a vehicle-to-everything pedestrian protection scenario as an example.

210: Receive the direct communication PC5 message.

In some embodiments, in a vehicle-to-everything pedestrian collision protection scenario, accurate positions of a pedestrian and a vehicle may be necessary. In a vehicle-to-everything industry standard, positioning accuracy used for the pedestrian collision protection scenario may be less than 1 meter. The higher the positioning accuracy, the more conducive it is to accurately detect a dangerous state and implement collision warning. Generally, an intersection, a T-junction, a parking lot, and other areas where pedestrians and vehicles travel together are areas with a high probability of collision. To ensure safety of the pedestrians in the areas, performing the collision warning based on the vehicle-to-everything system may be necessary.

The pedestrian may carry a vehicle-to-everything terminal that may be configured to construct a collision warning system and perform positioning. In some embodiments, because positioning and the collision warning may be implemented based on a PC5 communication interface, the vehicle-to-everything terminal, a road side unit, and a vehicle that form the collision warning system may be equipped with PC5 communication modules. The PC5 communication module in some embodiments may be a C-V2X PC5 communication module.

FIG. 3 exemplarily shows a schematic structural diagram of a vehicle-to-everything dedicated pedestrian terminal. As shown in FIG. 3, a vehicle-to-everything dedicated pedestrian terminal 300 includes a central processing unit 301, a C-V2X PC5 communication module 302, a positioning module 303, a battery and power management module 304, another auxiliary module 305, a PC5 antenna 306, and a positioning module antenna 307. The PC5 antenna 306 is connected to the C-V2X PC5 communication module 302, and the positioning module antenna 307 is connected to the positioning module 303.

After receiving a PC5 message transmitted by a target road side unit, the vehicle-to-everything dedicated pedestrian terminal shown in FIG. 3 may activate the positioning module 303 to perform positioning, and transmit, based on obtaining positioning information, the positioning information to a vehicle through the C-V2X PC5 communication module 302, to implement collision warning.

For a terminal, such as a smart phone, a laptop computer, or a smart bracelet, that is equipped with a cellular communication module, the C-V2X PC5 communication module and the positioning module configured for high-accuracy positioning may be disposed in the terminal. Some functionality of the cellular communication module may be disabled, and the C-V2X PC5 communication module and the positioning module activated, to further reduce power consumption and improve positioning accuracy.

In some embodiments, the C-V2X PC5 communication module has a PC5 communication receiving function and a PC5 communication transmitting function. To reduce power consumption of a vehicle-to-everything terminal, during running of the vehicle-to-everything terminal, the PC5 communication receiving function is always in an activated state, to ensure that the vehicle-to-everything terminal can receive PC5 messages that are transmitted from a road side unit and a vehicle. However, the PC5 communication transmitting function may be activated based on positioning information to be transmitted to the vehicle.

In some embodiments, during a movement process of a pedestrian, the vehicle-to-everything terminal receives PC5 messages transmitted by terminals such as the road side unit and the vehicle in the vehicle-to-everything system through PC5 communication interfaces. However, a trigger condition for the vehicle-to-everything terminal to start to perform positioning is receiving the PC5 message transmitted by the target road side unit. Therefore, the vehicle-to-everything terminal may parse the received PC5 message and determine whether the PC5 message is a message transmitted by the target road side unit. If the PC5 message is the message transmitted by the target road side unit, the positioning module is turned on to perform positioning. If the PC5 message is not the message transmitted by the target road side unit, the PC5 messages are continuously detected, until the PC5 message transmitted by the target road side unit is received.

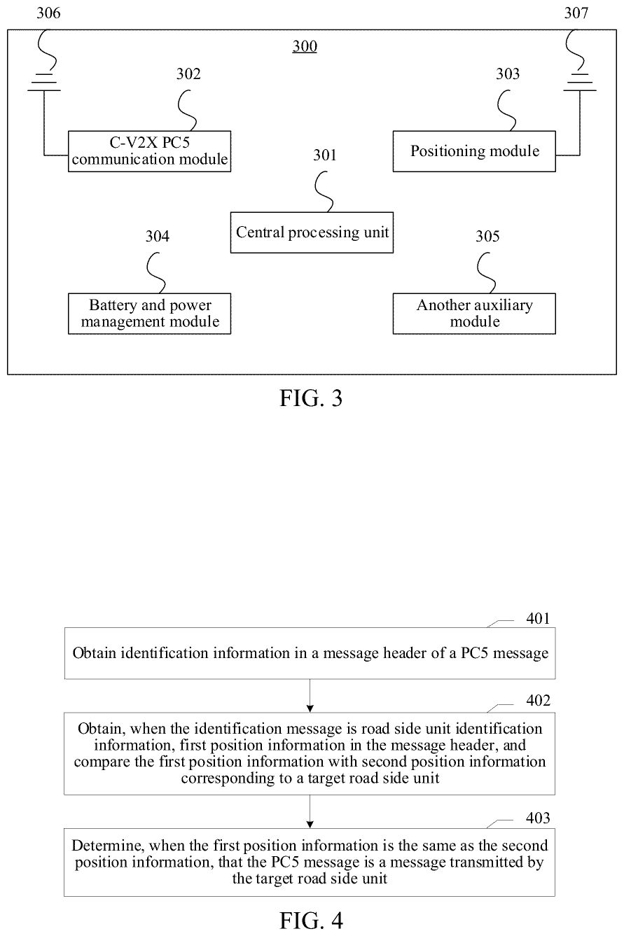

FIG. 4 exemplarily shows a schematic flowchart of determining that a received PC5 message is a message transmitted by a target road side unit. As shown in FIG. 4, 401: Obtain identification information of a message header of the PC5 message. 402: Obtain, based on the identification information being road side unit identification information, first position information in the message header, and compare the first position information with second position information corresponding to the target road side unit. 403: Determine, based on the first position information being the same as the second position information, that the PC5 message is the message transmitted by the target road side unit.

In 401, the PC5 message includes the message header, and the message header includes the identification information and device position information. Specifically, the identification information is identification information corresponding to a road side unit or identification information corresponding to a vehicle. The device position information is positioning information corresponding to the road side unit or positioning information corresponding to the vehicle. Because the road side unit may be disposed at an intersection, the position information corresponding to the road side unit may be intersection positioning information. After parsing the PC5 message transmitted by the road side unit to obtain the first position information corresponding to the road side unit, the first position information may be compared with the second position information corresponding to the target road side unit. If the first position information is the same as the second position information, the PC5 message is the message transmitted by the target road side unit.

Further, a map marking the target road side unit is stored in a vehicle-to-everything terminal, and the vehicle-to-everything terminal may obtain the second position information corresponding to the target road side unit from the map, to determine whether the received PC5 message is the PC5 message transmitted by the target road side unit. The map marking the target road side unit may be already configured when the vehicle-to-everything terminal is manufactured. When there is update of the map subsequently, the update of the map may be completed by system update performed by a terminal manufacturer. Alternatively, the map marking the target road side unit may be transmitted by a vehicle-to-everything server to the vehicle-to-everything terminal. After receiving the map transmitted by the vehicle-to-everything server, the vehicle-to-everything terminal may update a locally stored map, so that the vehicle-to-everything terminal performs positioning based on an updated map.

220: When it is determined that the PC5 message is the message transmitted by the target road side unit, activate the positioning module to perform positioning, and perform positioning in the movement process in the different positioning modes according to the current terminal position, the positioning accuracy of the positioning mode being improved as the distance between the current terminal position and the collision-prone area decreases, and being reduced as the distance increases.

In some embodiments, based on it being determined that the PC5 message is the message transmitted by the target road side unit, the vehicle-to-everything terminal enters the signal coverage area of the target road side unit. The vehicle-to-everything terminal may turn on the positioning module to perform positioning to obtain the positioning information. When positioning is performed by using the positioning module, power consumption may be increased, and in addition, positioning accuracy may be affected. In some embodiments, different positioning modes may be turned on level-by-level according to the current terminal position, to balance the power consumption and the positioning accuracy. Based on the different positioning modes being turned on level-by-level according to the current terminal position, the different positioning modes may be determined according to the distance between the current terminal position and the collision-prone area. The positioning accuracy of the positioning mode may be improved as the distance between the current terminal position and the collision-prone area decreases, and may be reduced as the distance increases. In other words, the closer to the collision-prone area, the higher the positioning accuracy of the positioning mode. The collision-prone area is an area where a pedestrian and a vehicle meet, such as an intersection area at a crossroad, an intersection area at a T-junction, or a passage where a pedestrian and a vehicle travel together in a parking lot.

In some embodiments, in the movement process of the vehicle-to-everything terminal, the signal coverage range of the target road side unit may be divided into a plurality of areas, and each area corresponds to a positioning mode with different positioning accuracy. Positioning accuracy of the positioning mode corresponding to each area may satisfy a rule that the closer to the collision-prone area, the higher the positioning accuracy, and the further away from the collision-prone area, the lower the positioning accuracy. However, considering a construction cost of a collision warning system, and considering that a signal coverage radius of the road side unit may be 300 meters to 500 meters, in some embodiments, the signal coverage area of the target road side unit may be divided into two areas. Positioning is performed in the two areas in different positioning modes. The signal coverage area of the target road side unit may include a first area and a second area that are arranged from outside to inside with the collision-prone area as a center. The second area includes the collision-prone area. When the vehicle-to-everything terminal is in the first area, positioning is performed in a first positioning mode. When the vehicle-to-everything terminal is in the second area, positioning is performed in a second positioning mode. Because a distance between the first area and the collision-prone area is greater than a distance between the second area and the collision-prone area, positioning accuracy of the first positioning mode is lower than positioning accuracy of the second positioning mode. When the vehicle-to-everything terminal can receive the PC5 message transmitted by the target road side unit, the vehicle-to-everything terminal enters an outermost side of the signal coverage area of the target road side unit, or the vehicle-to-everything terminal enters the first area. Therefore, based on the PC5 message transmitted by the target road side unit being received, the positioning module may be activated, and positioning may be performed in the first positioning mode corresponding to the first area, to obtain the positioning information.

In some embodiments, based on the signal coverage area of the target road side unit being divided, a boundary distance may be determined based on factors such as a corrected road width and a warning advance, and a boundary is determined based on the boundary distance and the collision-prone area, thereby dividing, according to the boundary, the signal coverage area of the target road side unit into the first area and the second area that are overlapped. The second area includes the collision-prone area.

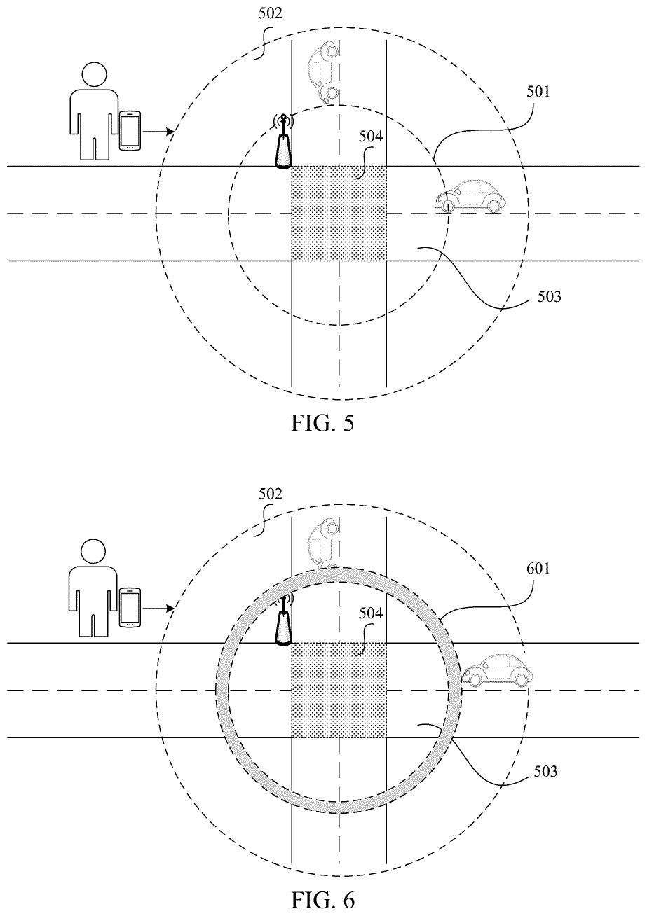

FIG. 5 exemplarily shows a schematic diagram of an interface in which a signal coverage area of a target road side unit located at an intersection is divided into a plurality of areas. As shown in FIG. 5, a signal coverage area 500 of the target road side unit is divided into a first area 502 and a second area 503 by a boundary 501, and the second area 503 includes a collision-prone area 504.

The boundary 501 is generated according to factors such as a corrected road width of the intersection and a warning advance. In some embodiments, the corrected road width is generated according to a road width in an urban road pavement design specification. For example, the corrected road width may be obtained by averaging a maximum value and a minimum value of a designed road width. The warning advance may be set according to an actual requirement. Considering a speed limit and a braking distance of a vehicle on an urban road, the warning advance may be set to 10 seconds to 20 seconds, and may be set to another value. A boundary distance may be determined based on the factors such as the corrected road width and the warning advance being obtained. The boundary distance may be, for example, 50 meters from a center point of the collision-prone area, and may be another value. However, it is clear that the boundary distance is less than a signal coverage radius of the target road side unit, and a shape of the boundary is not limited to the circle shown in FIG. 4. For example, the boundary may also be arranged to be a rectangle boundary, a square boundary, or the like according to the boundary distance based on a road edge. This is not limited.

In some embodiments, the first area and the second area may be pre-arranged, or may be formed in a manner that a vehicle-to-everything terminal divides the signal coverage area of the target road side unit according to area division logic based on receiving a map marking the target road side unit. However, considering a computation capability and positioning efficiency of the vehicle-to-everything terminal, in some embodiments, arrangement of the first area and the second area is mainly that the first area and the second area are pre-arranged and marked on the map, and may not use excessive calculations by the vehicle-to-everything terminal.

In some embodiments, because positioning accuracy cannot reach zero, based on a pedestrian wandering near the boundary, deviation of a positioning mode determined by the vehicle-to-everything terminal may result. For example, a current terminal position is in the first area and is close to the boundary. However, due to a positioning deviation, the current terminal position may be determined to be in the second area, thereby resulting in a positioning mode selection error. In some embodiments, a bandwidth area may be constructed based on forming the boundary distance of the boundary. The boundary distance may not be a fixed value, but a range value. A bandwidth area may exist between the first area and the second area after area division, so that constant jumps of the positioning mode near the boundary may be reduced based on area determination being performed in a lower positioning accuracy. For example, if the boundary distance is 50 meters, a bandwidth range may be set to ±10 meters, and boundary values corresponding to the bandwidth area are 40 meters and 60 meters. In addition, ranges of the first area and the second area are reduced accordingly. The bandwidth range may be adjusted according to an actual requirement, including but not limited to the foregoing bandwidth range.

Based on the schematic diagram of the interface in which the signal coverage area of the target road side unit located at the intersection is divided into the plurality of areas shown in FIG. 5, FIG. 6 shows a schematic diagram of a division interface of an area with a bandwidth area. As shown in FIG. 6, a bandwidth area 601 is formed between the first area 502 and the second area 503.

In some embodiments, based on the vehicle-to-everything terminal entering the bandwidth area, a used positioning mode may be based on a movement direction of the terminal. By using the schematic diagram of the division interface of the area shown in FIG. 6 as an example, if the vehicle-to-everything terminal is in the bandwidth area, based on the movement direction facing the collision-prone area, or based on the vehicle-to-everything terminal to be entering the second area, positioning may be performed in a second positioning mode, to obtain positioning information. If the vehicle-to-everything terminal is in the bandwidth area, based on the movement direction being away from the collision-prone area, or based on the vehicle-to-everything terminal to be entering the first area, positioning may be performed in a first positioning mode, to obtain the positioning information.

In some embodiments, positioning accuracy of the first positioning mode is lower than positioning accuracy of the second positioning mode. In addition, a positioning module performs positioning in the signal coverage area of the target road side unit. However, the signal coverage radius of the target road side unit is 300 meters to 500 meters. Therefore, to improve the positioning accuracy, the positioning accuracy of the first positioning mode is to be lower than a hundred-meter level, and may be, for example, a ten-meter level or a meter level. The positioning accuracy of the second positioning mode is high, and may be, for example, a sub-meter level. In some embodiments, the used first positioning mode may be a GNSS positioning mode, and the positioning accuracy thereof may reach 10 meters. The used second positioning mode may be a C-V2X PC5-based GNSS-RTK positioning mode, and the positioning accuracy thereof may be less than 1 meter.

GNSS positioning is positioning performed based on a global satellite navigation system. Satellites are distributed in different positions in a three-dimensional space. A distance between a receiver (the vehicle-to-everything terminal) and each satellite can be calculated by using a time difference of receiving signals emitted by the satellites by the receiver (the vehicle-to-everything terminal). After distances between the receiver (the vehicle-to-everything terminal) and at least three satellites are known, a three-dimensional position of the receiver (the vehicle-to-everything terminal) may be calculated through triangulation.

When positioning is performed in the C-V2X PC5-based GNSS-RTK positioning mode, the target road side unit receives a RTK differential correction signal transmitted by a high-accuracy positioning base station through a PC5 communication interface, and then transmits the RTK differential correction signal to the vehicle-to-everything terminal through the PC5 communication interface. After receiving the RTK differential correction signal, the vehicle-to-everything terminal may correct, according to the RTK differential correction signal, initial GNSS positioning information measured by a GNSS positioning module of the vehicle-to-everything terminal, to obtain the positioning information.

The C-V2X PC5-based GNSS-RTK positioning mode is different from a cellular network-based GNSS-RTK positioning mode. Generally, in a GNSS-RTK positioning mode, the RTK differential correction signal is transmitted through a cellular network. However, because receiving the RTK differential correction signal through the cellular network is greatly affected by a cellular network signal, reception of the RTK differential correction signal may be unstable. Therefore, in some embodiments, positioning is performed in the C-V2X PC5-based GNSS-RTK positioning mode. A collision warning system includes the target road side unit, and broadcasting the RTK differential correction signal through the target road side unit is an addition to a software function based on an original system. Without increasing a complexity degree of a hardware system and additional deployment investment, a RTK positioning support capability is improved, and reliability of RTK positioning of the vehicle-to-everything terminal is improved. In addition, arrangement of a cellular communication module is further avoided, so that a system construction cost is reduced.

In some embodiments, based on performing positioning in positioning modes with different positioning accuracy according to different areas in which the current terminal position is located, the vehicle-to-everything terminal may also perform positioning by using different positioning frequencies, the positioning frequency may also be increased as a distance between the current terminal position and the collision-prone area decreases, and the positioning frequency may be decreased as the distance increases. The vehicle-to-everything terminal may obtain a positioning mode mapping table while obtaining the map marking the target road side unit. The positioning mode mapping table includes a plurality of areas, and positioning modes and positioning frequencies that correspond to the areas. In addition, as a distance between each area and the collision-prone area decreases, positioning accuracy of the positioning mode corresponding to each area is improved, and a positioning frequency of the positioning mode corresponding to each area increases. As the distance increases, the positioning accuracy is reduced, and the positioning frequency decreases. The positioning accuracy and power consumption of the terminal may be further balanced, the positioning accuracy and collision warning accuracy may be improved, the power consumption of the terminal may be reduced, and battery life of the terminal may be extended.

In some embodiments, based on an area in which the current terminal position is located being determined, the determined area may be compared with an area in the positioning mode mapping table. When the area exists in the positioning mode mapping table, a corresponding positioning mode and a corresponding positioning frequency are obtained to be used as a target positioning mode and a target positioning frequency.

By using the schematic diagram of the interface in which the signal coverage area of the target road side unit located at the intersection is divided into the plurality of areas shown in FIG. 5 as an example, a corresponding positioning mode mapping table includes the first area, the second area, the first positioning mode and a first positioning frequency that correspond to the first area, and the second positioning mode and a second positioning frequency that correspond to the second area. When it is determined that the current terminal position is in the first area, the first positioning mode is used as the target positioning mode, and the first positioning frequency is used as the target positioning frequency. When it is determined that the current terminal position is in the second area, the second positioning mode is used as the target positioning mode, and the second positioning frequency is used as the target positioning frequency.

In some embodiments, although the closer to the collision-prone area, the higher the positioning frequency is, which may ensure an appropriate warning advance, thereby avoiding occurrence of a collision, the positioning frequency is not arbitrarily set. In some embodiments, a premise of designing the positioning frequency is that within a time interval of two times of positioning, a movement position of a pedestrian is smaller than positioning accuracy of an area in which the pedestrian is located. Therefore, in some embodiments, the positioning frequency may be set according to factors such as a positioning accuracy requirement, a movement rate of the pedestrian, and a security coefficient. The security coefficient is set to prevent the positioning frequency from being too low, resulting in inability to obtain updated positioning information for a long time after a signal is lost. The closer the area in which the current terminal position is located to the collision-prone area, the higher the security coefficient is set.

In some embodiments, for each area, the positioning frequency may be obtained from a corresponding frequency range, and the frequency range includes a minimum frequency reference value and a maximum frequency reference value. The minimum frequency reference value may be calculated according to the positioning accuracy requirement, the movement rate of the pedestrian, and the security coefficient that are for the area in which the current terminal position is located, and the maximum frequency reference value is a minimum frequency reference value corresponding to a sensing area adjacent to and close to the collision-prone area. A calculation formula of the minimum frequency reference value is shown in the following formula (1):

$${F}_{x - min} = ( 1 * α ) / ( p / v ) \qquad ( 1 )$$

Fₓ₋ₘᵢₙ is the minimum frequency reference value, α is the security coefficient, p is the positioning accuracy, and v is the movement rate.

By using the schematic diagram of the interface in which the area is divided in FIG. 5 as an example, positioning accuracy and a positioning frequency that are of a positioning mode corresponding to a second sensing area are the highest. Positioning accuracy and a positioning frequency that are of a positioning mode corresponding to a first sensing area are the lowest. In the GNSS positioning mode and the C-V2X PC5-based GNSS-RTK positioning mode, positioning accuracy of the GNSS positioning mode is low and is about 10 meters, and positioning accuracy of the C-V2X PC5-based GNSS-RTK positioning mode is high and reaches the sub-meter level. Therefore, in some embodiments, a positioning mode corresponding to the first area may be set to the GNSS positioning mode, and a corresponding security coefficient is 2.5. A positioning mode corresponding to the second area may be set to the C-V2X PC5-based GNSS-RTK positioning mode, and a security coefficient is 5.

In addition, considering that a moving speed of the pedestrian may not be greater than 2 meters per second, according to the formula (1), minimum frequency reference values that correspond to the first sensing area and the second sensing area may be obtained as 0.5 Hz and 10 Hz respectively. Correspondingly, a positioning frequency corresponding to the first area is within a frequency range [0.5, 10), and a positioning frequency corresponding to the second area is within a frequency range [10, ∞). After obtaining a frequency range corresponding to each area, a positioning frequency corresponding to the area may be determined from the corresponding frequency range. For example, according to actual application, and taking power consumption reduction and positioning data reliability into account, the positioning frequency corresponding to the first area may be set to 1 Hz, and the positioning frequency corresponding to the second area may be set to 10 Hz. In other words, based on the pedestrian entering the first area within a signal coverage range of the target road side unit, the current terminal position may be in the first area, a corresponding positioning mode may be the GNSS positioning mode, and a positioning frequency may be 1 HZ. The GNSS positioning module may be triggered to perform GNSS positioning once every 1 second, to obtain positioning information. When the pedestrian enters the second area, a corresponding positioning mode is the C-V2X PC5-based GNSS-RTK positioning mode, and a positioning frequency is 10 Hz. The GNSS positioning module may be triggered to perform C-V2X PC5-based GNSS-RTK positioning once every 0.1 seconds, to obtain positioning information.

For the schematic diagram of the division interface of the area shown in FIG. 6, based on the current terminal position being in the bandwidth area 601, a positioning frequency used based on the vehicle-to-everything terminal performing positioning in the bandwidth area may also be determined according to a movement direction of the pedestrian. Based on the movement direction facing the collision-prone area, or based on the vehicle-to-everything terminal to be entering the second area, positioning may be performed in the second positioning mode by using the second positioning frequency, to obtain positioning information. Based on the movement direction being away from the collision-prone area, and based on the vehicle-to-everything terminal to be entering the first area, positioning may be performed in the first positioning mode by using the first positioning frequency, to obtain the positioning information.

In some embodiments, based on performing positioning in the first positioning mode, the vehicle-to-everything terminal turns off a PC5 message transmitting function of a C-V2X PC5 communication module, activates a PC5 message receiving function, and activates the positioning module to perform positioning. When performing positioning in the second positioning mode, the vehicle-to-everything terminal activates the PC5 message transmitting function of the C-V2X PC5 communication module based on activating the PC5 message receiving function and the positioning module, and transmits the positioning information to a vehicle through the PC5 communication interface, so that the vehicle performs collision warning based on the positioning information and a real-time position of the vehicle. A message transmitting frequency may be reduced, the power consumption of the vehicle-to-everything terminal may be further reduced, and the battery life may be further extended.

In some embodiments, the PC5 message transmitting function of the C-V2X PC5 communication module is activated based on positioning being performed in the C-V2X PC5-based GNSS-RTK positioning mode. Based on the positioning information being obtained, based on the PC5 message transmitting function, the positioning information may be transmitted to a vehicle that may communicate with the vehicle-to-everything terminal through the PC5 communication interface, so that the vehicle determines whether there is a possibility of collision between the vehicle and the pedestrian based on the positioning information and a real-time position of the vehicle. If there is a possibility of collision, collision warning is performed.

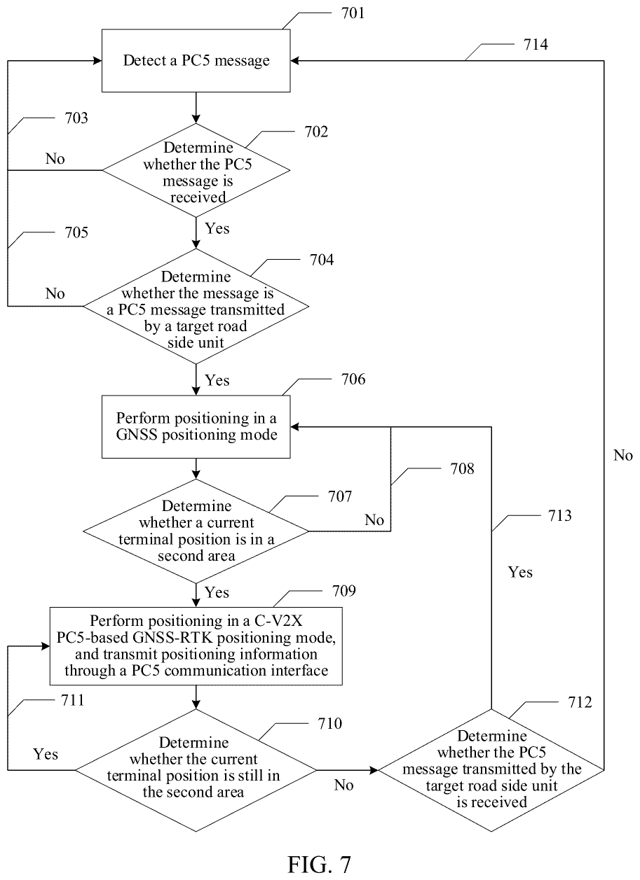

Based on the schematic diagram of the interface in which the area is divided in FIG. 5, FIG. 7 is a schematic flowchart of switching a positioning mode. As shown in FIG. 7, 701: The vehicle-to-everything terminal activates a PC5 communication receiving function, and detects a PC5 message. 702: Determine whether the PC5 message is received. 703: When it is determined that the PC5 message is not received, continue to perform 701. 704: When it is determined that the PC5 message is received, parse the received PC5 message, and determine whether the message is a PC5 message transmitted by the target road side unit. 705: When it is determined that the PC5 message is not transmitted by the target road side unit, continue to perform 701 and 702. 706: When it is determined that the PC5 message is transmitted by the target road side unit, activate a GNSS positioning module, and perform positioning in a GNSS positioning mode. 707: Obtain the current terminal position, and determine an area in which the current terminal position is located. 708: When it is determined that the current terminal position is in the first area, continue to perform positioning in the GNSS positioning mode. 709: When it is determined that the current terminal position is in the second area, perform positioning in a C-V2X PC5-based GNSS-RTK positioning mode, to obtain positioning information, activate a PC5 message transmitting function, and transmit the positioning information through a PC5 communication interface. 710: Determine whether the current terminal position is in the second area. 711: When it is determined that the current terminal position is in the second area, continue to perform positioning in the C-V2X PC5-based GNSS-RTK positioning mode and transmit the positioning information through the PC5 communication interface. 712: When it is determined that the current terminal position is not in the second area, determine whether the PC5 message transmitted by the target road side unit is received. 713: When it is determined that the PC5 message transmitted by the target road side unit is received, continue to perform positioning in the GNSS positioning mode. 714: When it is determined that the PC5 message transmitted by the target road side unit is not received, turn off the GNSS positioning module, and detect the PC5 message.

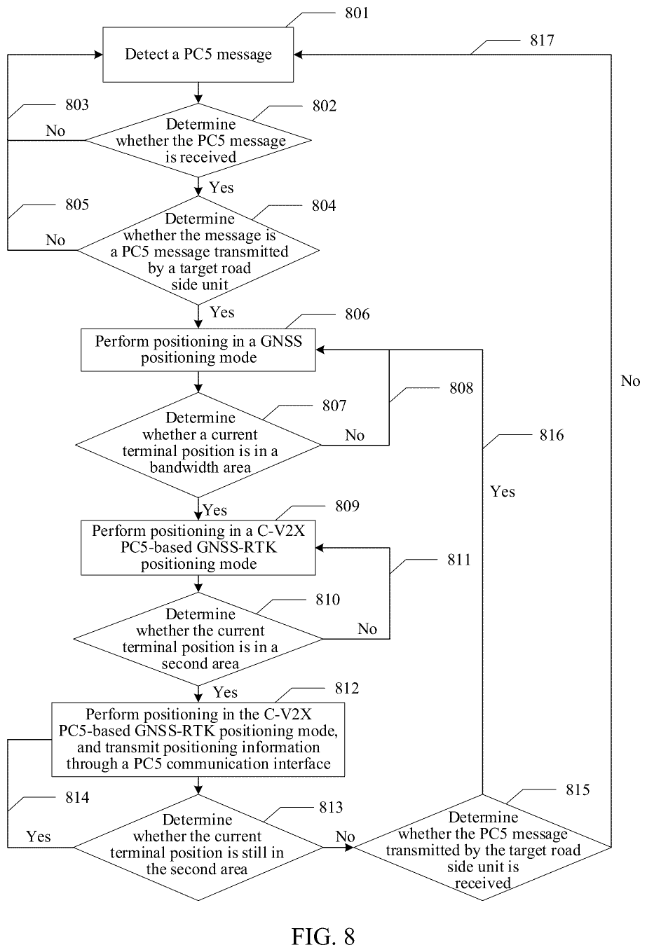

Based on the schematic diagram of the interface in which the area is divided in FIG. 6, FIG. 8 is a schematic flowchart of switching a positioning mode. As shown in FIG. 8, 801: The vehicle-to-everything terminal activates a PC5 communication receiving function, and detects a PC5 message. 802: Determine whether the PC5 message is received. 803: When it is determined that the PC5 message is not received, continue to perform 801. 804: When it is determined that the PC5 message is received, parse the received PC5 message, and determine whether the message is a PC5 message transmitted by the target road side unit. 805: When it is determined that the PC5 message is not transmitted by the target road side unit, continue to perform 801 and 802. 806: When it is determined that the PC5 message is transmitted by the target road side unit, activate the GNSS positioning module, and perform positioning in the GNSS positioning mode. 807: Obtain the current terminal position, and determine whether the current terminal position is in the bandwidth area. 808: When it is determined that the current terminal position is in the first area, continue to perform positioning in the GNSS positioning mode. 809: When it is determined that the current terminal position is in the bandwidth area, and the movement direction faces the collision-prone area, perform positioning in the C-V2X PC5-based GNSS-RTK positioning mode, to obtain the positioning information. 810: Determine whether the current terminal position is in the second area. 811: When it is determined that the current terminal position is in the bandwidth area, perform positioning in the C-V2X PC5-based GNSS-RTK positioning mode, to obtain the positioning information. 812: When it is determined that the current terminal position is in the second area, perform positioning in the C-V2X PC5-based GNSS-RTK positioning mode, to obtain the positioning information, activate the PC5 message transmitting function, and transmit the positioning information through the PC5 communication interface. 813: Determine whether the current terminal position is in the second area. 814: When it is determined that the current terminal position is in the second area, continue to perform positioning in the C-V2X PC5-based GNSS-RTK positioning mode and transmit the positioning information through the PC5 communication interface. 815: When it is determined that the current terminal position is not in the second area, determine whether the PC5 message transmitted by the target road side unit is received. 816: When it is determined that the PC5 message transmitted by the target road side unit is received, continue to perform positioning in the GNSS positioning mode. 817: When it is determined that the PC5 message transmitted by the target road side unit is not received, turn off the GNSS positioning module, and detect the PC5 message.

For the schematic flowcharts of switching the positioning mode shown in FIG. 7 and FIG. 8, the positioning frequency may also be switched based on the positioning mode being switched. For example, in operations 706, 708, and 713, positioning is performed by using a corresponding positioning frequency (for example, 1 Hz) based on positioning being performed in the GNSS positioning mode. In operations 709 and 711, positioning is performed by using a corresponding positioning frequency (for example, 10 Hz) based on positioning being performed in the C-V2X PC5-based GNSS-RTK positioning mode. Similarly, in operations 806, 808, and 816, positioning is performed by using a corresponding positioning frequency (for example, 1 Hz) based on positioning being performed in the GNSS positioning mode. In operations 809, 811, 812, and 814, positioning is performed by using a corresponding positioning frequency (for example, 10 Hz) based on positioning being performed in the C-V2X PC5-based GNSS-RTK positioning mode.

The terminal positioning method in some embodiments is applicable to protection for a pedestrian, a non-motor vehicle driver, and a user of a special vehicle (for example, a wheelchair) that are in a vehicle-to-everything system. By using an example in which protection for a vehicle-to-everything pedestrian is performed in an intersection area arranged with a road side unit, the terminal positioning method in some embodiments is described below.

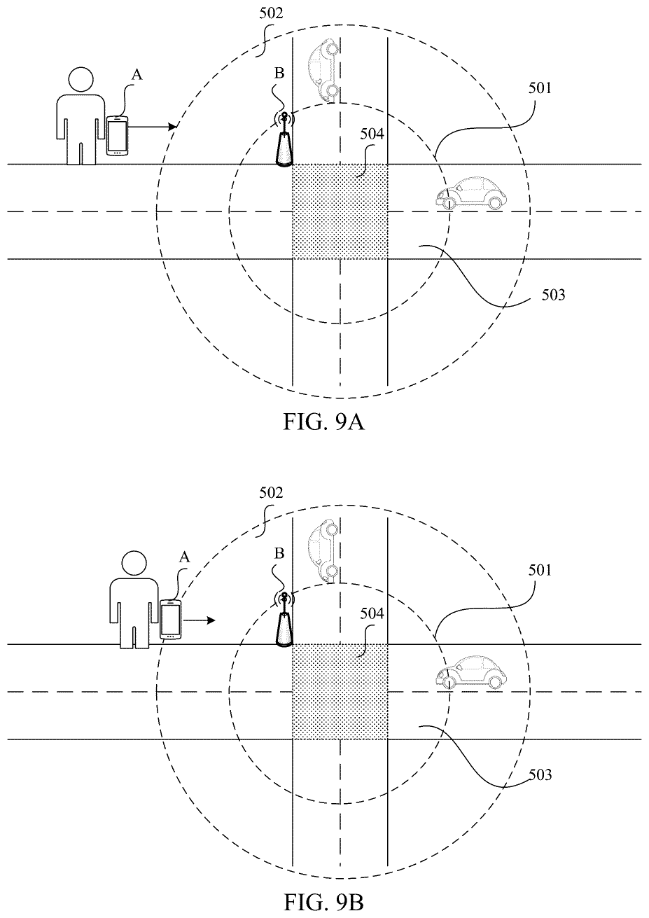

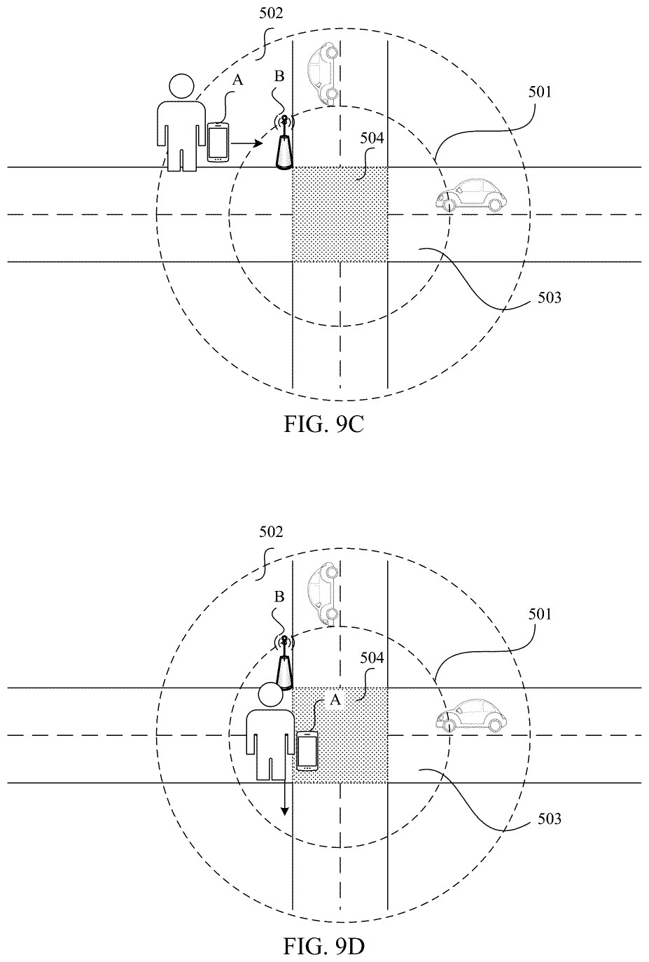

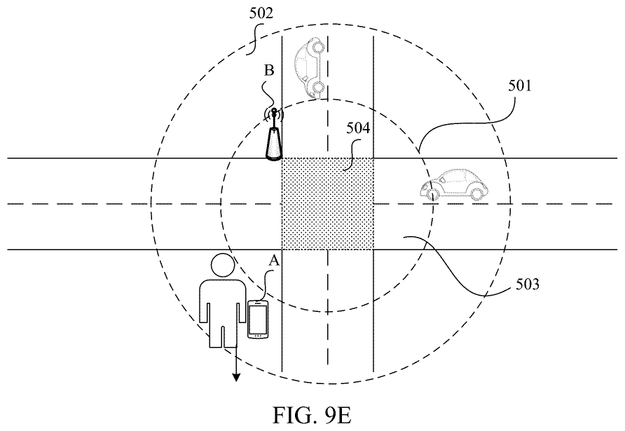

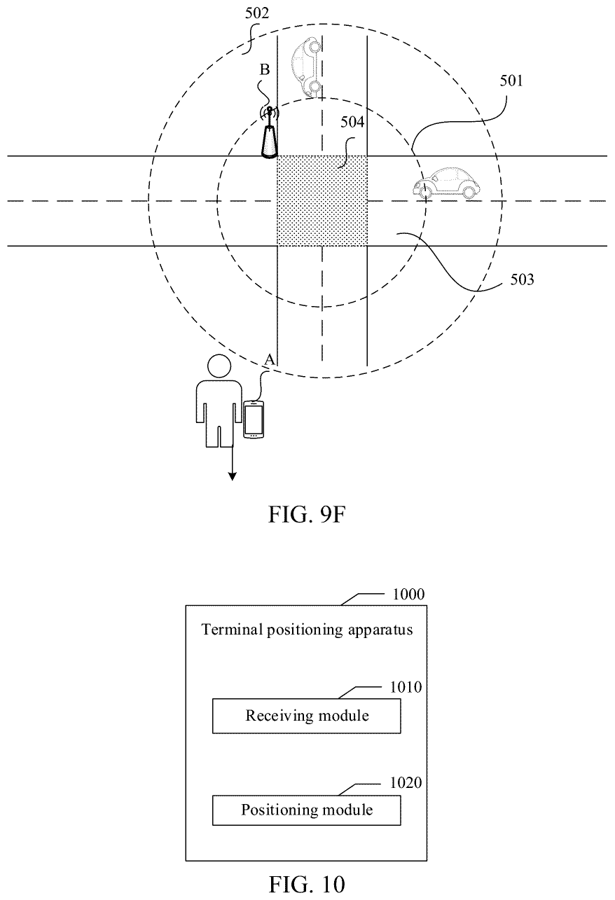

Based on the schematic diagram of the interface in which the area is divided in FIG. 5, FIG. 9A to FIG. 9F are schematic diagrams of changing interfaces of an area in which a vehicle-to-everything terminal is located and a positioning mode used during movement. As shown in FIG. 9A, a pedestrian carries a vehicle-to-everything terminal A and moves to an intersection. Only a PC5 message receiving function of a C-V2X PC5 communication module may be activated, and a PC5 message transmitting function and a positioning function of a positioning module may be turned off, to cause the vehicle-to-everything terminal A to be in a low power consumption detection mode. As shown in FIG. 9B, based on the vehicle-to-everything terminal A receiving a PC5 message transmitted by a road side unit B arranged at the intersection, the positioning module is activated, and positioning is performed in a GNSS positioning mode, to obtain positioning information. As shown in FIG. 9C, in a movement process of the vehicle-to-everything terminal A, a current terminal position is obtained. When the current terminal position is in a first area D1, positioning is continuously performed in the GNSS positioning mode, to obtain the positioning information. As shown in FIG. 9D, based on the current terminal position being in a second area D2, positioning is performed in a C-V2X PC5-based GNSS-RTK positioning mode, to obtain the positioning information. In addition, the PC5 message transmitting function is activated, and the positioning information is transmitted to a vehicle around the intersection through a PC5 communication interface, so that the vehicle performs collision warning according to the positioning information. As shown in FIG. 9E, based on the vehicle-to-everything terminal A leaving the second area D2 including the intersection, whether the PC5 message transmitted by the road side unit B is received is determined. When it is determined that the PC5 message is received, the PC5 message transmitting function is turned off, and positioning is performed in the GNSS positioning mode. As shown in FIG. 9F, based on the PC5 message not being received, the positioning module and the PC5 message transmitting function may be turned off, and PC5 message detection may be performed based on the PC5 message receiving function.

When the vehicle-to-everything terminal A leaves the second area, whether positioning is performed in the positioning mode is determined not according to the current terminal position, but according to whether the PC5 message is received. This is because power consumption of detecting the PC5 message is lower than power consumption of obtaining the current terminal position. Power consumption of the vehicle-to-everything terminal may be further reduced, and battery life may be further extended.

In some embodiments, based on the current terminal position being in the second area, positioning may be performed in a C-V2X PC5-based GNSS-Real Time Differential (RTD) positioning mode other than the C-V2X PC5-based GNSS-RTK positioning mode. Accuracy may be slightly reduced, but a collision warning requirement may also be satisfied in a scenario in which the vehicle-to-everything terminal moves at a low speed.

In some embodiments, the terminal positioning method may be actively triggered by the vehicle-to-everything terminal. For example, based on the vehicle-to-everything terminal being detected to be in a movement state, the C-V2X PC5 communication module may be triggered to perform PC5 message detection. In addition, after the PC5 message transmitted by the target road side unit is detected, the positioning module may be activated to perform positioning. The terminal positioning method may also be implemented by triggering an APP or an applet of a scenario such as a vehicle-to-everything terminal pedestrian protection scenario. A terminal user may download, from the vehicle-to-everything terminal, an application that may be used in the scenario such as the vehicle-to-everything terminal pedestrian protection scenario. When the terminal user plans to go out, the application or the applet may be triggered in advance, to cause the application or the applet to run in the background. During movement of the terminal user, the vehicle-to-everything terminal continues to detect received PC5 messages. When the PC5 message transmitted by the target road side unit is received, the positioning module is activated to perform positioning. If it is determined that the current terminal position is in the first area, positioning is performed in the GNSS positioning mode. If it is determined that the current terminal position is in the second area, positioning is performed in the C-V2X PC5-based GNSS-RTK positioning mode, the PC5 message transmitting function is activated, and the positioning information is transmitted to the vehicle through the PC5 communication interface, so that the vehicle may determine, according to the positioning information and a real-time position of the vehicle, whether a collision is to occur. When it is determined that a collision may occur, warning information is generated, so that a vehicle driver or a vehicle avoidance system performs avoidance.

In the terminal positioning method in some embodiments, during running, a vehicle-to-everything terminal receives PC5 messages transmitted by a road side unit and a vehicle, and determines, by parsing the PC5 message, whether the PC5 message is a message transmitted by a target road side unit. When it is determined that the PC5 message is transmitted by the target road side unit, the vehicle-to-everything terminal activates a positioning module to perform positioning, and performs positioning in a movement process in different positioning modes according to a current terminal position, to obtain positioning information.

Positioning can be triggered based on receiving the PC5 message transmitted by the target road side unit. There may be no need to turn on the positioning module out of a signal coverage range of the target road side unit if the PC5 message is detected, and power loss of the terminal may therefore be reduced.

During positioning, positioning is performed in different positioning modes according to different positions of the vehicle-to-everything terminal, and positioning accuracy of the positioning mode is improved as a distance between the vehicle-to-everything terminal and a collision-prone area decreases, and is reduced as the distance increases. The positioning accuracy may be improved by turning on the positioning mode level by level, thereby improving accuracy of collision warning. In addition, performing positioning in different positioning modes may further reduce positioning power consumption and extend battery life of the vehicle-to-everything terminal.

During positioning, positioning is performed in different positioning modes by using different positioning frequencies according to different positions of the vehicle-to-everything terminal. In addition, positioning accuracy of the positioning mode is improved as a distance between the vehicle-to-everything terminal and a collision-prone area decreases, and is reduced as the distance increases, and the positioning frequency of the positioning mode increases as the distance decreases, and decreases as the distance increases. In addition to ensuring the positioning accuracy and the accuracy of the collision warning, the positioning power consumption may be further reduced, and battery life of the vehicle-to-everything terminal may be further extended.

An RTK differential correction signal is broadcast by the road side unit through a PC5 communication interface rather than being transmitted through a cellular network. Therefore, an RTK positioning support capability and reliability of RTK positioning are improved, arrangement of a cellular communication module is avoided, and a manufacturing cost is reduced.

The vehicle-to-everything terminal may implement the terminal positioning method in some embodiments based on a C-V2X PC5 communication module. No cellular communication module is used. Therefore, an unnecessary hardware module is reduced, and power consumption and a hardware cost are reduced. In addition, usage cost may be reduced compared to cellular communication, because there are not communication fees.

When a positioning state is switched, considering the positioning accuracy, a bandwidth area is arranged, to avoid a jump of the positioning state at a boundary.

In the terminal positioning method in some embodiments, implementation difficulty and system complexity are reduced by adjusting a positioning manner and the positioning frequency to switch the positioning mode base on a mature positioning mode.

Data such as the positioning information, the current terminal position, and the current vehicle position may be involved. When some embodiments are applied to a product or technology, permission or consent of the terminal user and the vehicle driver may be required, and relevant collection, use, and processing of data may be required to comply with relevant laws, regulations, and standards of relevant countries and regions.

Although the operations according to some embodiments are described in a given order in the accompanying drawings, this does not require or imply that the operations must be performed in the recited order, or that all the operations shown must be performed to achieve an expected result. Additionally, some operations may be omitted, a plurality of operations may be combined into one operation, and/or one operation may be decomposed into a plurality of operations for execution, and the like.

The following describes an apparatus according to some embodiments, and some embodiments may be configured for performing the terminal positioning method in some embodiments. FIG. 10 exemplarily shows a block diagram of a structure of a terminal positioning apparatus according to some embodiments. As shown in FIG. 10, a terminal positioning apparatus 1000 includes a receiving module 1010 and a positioning module 1020.

The receiving module 1010 may be configured to receive a direct communication PC5 message; and the positioning module 1020 may be configured to, based on it being determined that the PC5 message is a message transmitted by a target road side unit, activate a positioning module to perform positioning, and perform positioning in a movement process in different positioning modes according to a current terminal position, positioning accuracy of the positioning mode being improved as a distance between the current terminal position and a collision-prone area decreases, and being reduced as the distance increases.

In some embodiments, a message header of the PC5 message includes identification information. The receiving module 1010 may be configured to obtain the identification information in the message header of the PC5 message; obtain, based on the identification information being road side unit identification information, first position information in the message header, and compare the first position information with second position information corresponding to the target road side unit; and determine, based on the first position information being the same as the second position information, that the PC5 message is the message transmitted by the target road side unit.

In some embodiments, a signal coverage area of the target road side unit includes a first area and a second area that are arranged from outside to inside with the collision-prone area as a center. The positioning module 1020 may include: a first positioning unit, configured to perform positioning in a first positioning mode based on the current terminal position being in the first area; and a second positioning unit, configured to perform positioning in a second positioning mode based on the current terminal position being in the second area, and based on positioning accuracy of the first positioning mode being lower than positioning accuracy of the second positioning mode.

In some embodiments, the positioning module 1020 may further include: a first functional unit, configured to turn off a PC5 message transmitting function based on performing positioning in the first positioning mode; and a second functional unit, configured to activate the PC5 message transmitting function and perform collision warning based on the PC5 message transmitting function based on performing positioning in the second positioning mode.

In some embodiments, the second positioning mode is a cellular vehicle-to-everything PC5-based GNSS-RTK positioning mode. The second functional unit may be configured to receive a RTK differential correction signal transmitted by the target road side unit through a PC5 communication interface; obtain initial positioning information, and correct the initial positioning information according to the RTK differential correction signal, to obtain positioning information; and transmit the positioning information to a vehicle through the PC5 communication interface, to cause the vehicle to perform collision warning according to the positioning information.

In some embodiments, the terminal positioning apparatus 1000 may include a determining module, configured to determine a target positioning mode according to a position relationship between the current terminal position and the second area based on a movement direction being away from the collision-prone area, and perform positioning in the target positioning mode.

In some embodiments, the determining module may include: a first determining unit, configured to use the second positioning mode as the target positioning mode based on the current terminal position being in the second area; and a second determining unit, configured to determine, based on the current terminal position being outside the second area, whether the PC5 message transmitted by the target road side unit is received, and perform a corresponding operation according to a determining result.

In some embodiments, the second determining unit may be configured to use the first positioning mode as the target positioning mode based on the PC5 message transmitted by the target road side unit being received; and stop positioning based on the PC5 message transmitted by the target road side unit not being received.

In some embodiments, a bandwidth area may be arranged between the first area and the second area; and the terminal positioning apparatus 1000 is further configured to, based on the current terminal position being in the bandwidth area, and the movement direction facing the collision-prone area, perform positioning in the second positioning mode, to obtain the positioning information; and based on the current terminal position being in the bandwidth area and the movement direction being away from the collision-prone area, perform positioning in the first positioning mode, to obtain the positioning information.

In some embodiments, the terminal positioning apparatus 1000 may be further configured to perform positioning by using different positioning frequencies based on performing positioning in different positioning modes, and based on the positioning frequency increasing as the distance between the current terminal position and the collision-prone area decreases, and decreasing as the distance increases.

In some embodiments, the first positioning mode may be a GNSS positioning mode, and the second positioning mode is the cellular vehicle-to-everything PC5-based GNSS-RTK positioning mode.

In some embodiments, the terminal positioning apparatus 1000 may be further configured to, before receiving the PC5 message, activate a PC5 message receiving function, turn off a positioning function and the PC5 message transmitting function, and obtain the PC5 message based on the PC5 message receiving function.

According to some embodiments, each module unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “modules” or “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

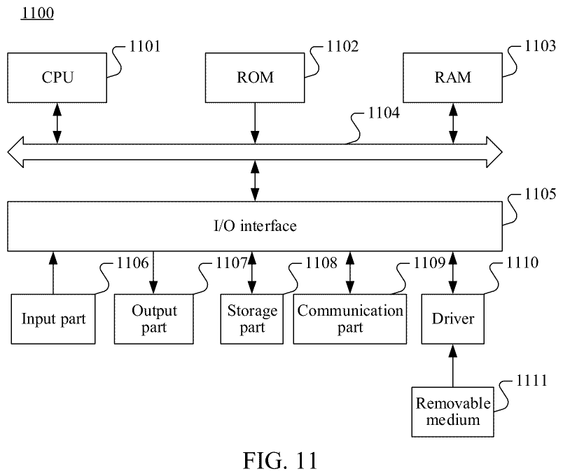

FIG. 11 is a schematic block diagram of a structure of a computer system of an electronic device for implementing some embodiments. The electronic device may be, as shown in FIG. 1, disposed in the vehicle-to-everything terminal 101, the road side unit 102, or the vehicle 103.

A computer system 1100 of the electronic device shown in FIG. 11 is an example according to some embodiments, and does not constitute any limitation on functions and use ranges.

As shown in FIG. 11, the computer system 1100 includes a central processing unit (CPU) 1101. The CPU 1101 may perform various appropriate actions and processing according to a program stored in a read-only memory (ROM) 1102 or a program loaded from a storage portion 1108 into a random access memory (RAM) 1103. The random access memory 1103 further stores various programs and data for system operations. The central processing unit 1101, the read-only memory 1102, and the random access memory 1103 are connected to each other through a bus 1104. An input/output (I/O) interface 1105 is also connected to the bus 1104.

In some embodiments, the following components are connected to the input/output interface 1105: an input part 1106 including a keyboard, a mouse, and the like; an output part 1107 including a cathode ray tube (CRT), a liquid crystal display (LCD), a loudspeaker, and the like; a storage part 1108 including hard disk, and the like; and a communication part 1109 including a network interface card such as an LAN card or a modem. The communication part 1109 performs communication processing by using a network such as the Internet. A driver 1110 may also connected to the input/output interface 1105. A removable medium 1111, such as a magnetic disk, an optical disc, a magneto-optical disk, or a semiconductor memory, may be mounted on the driver 1110, so that a computer program read from the removable medium may be installed into the storage part 1108.

According to some embodiments, the processes described may be implemented as computer software programs. For example, some embodiments include a computer program product, the computer program product includes a computer program carried on a computer-readable medium, and the computer program includes program code configured for performing the methods shown in the flowcharts. In some embodiments, the computer program may be downloaded and installed from a network through the communication part 1109, and/or installed from the removable medium 1111. When the computer program is executed by the central processing unit 1101, various functions are executed.

The computer-readable medium shown in some embodiments may be a computer-readable signal medium or a computer-readable medium or any combination thereof. The computer-readable medium may be, for example, but is not limited to, an electrical, magnetic, optical, electromagnetic, infrared, or semiconductor system, apparatus, or device, or any combination thereof. Additional examples of the computer-readable medium may include but are not limited to: an electrical connection having one or more wires, a portable computer magnetic disk, a hard disk, a RAM, a ROM, an erasable programmable read-only memory (EPROM), a flash memory, an optical fiber, a compact disc read-only memory (CD-ROM), an optical storage device, a magnetic storage device, or any appropriate combination thereof. The computer-readable medium may be any tangible medium including or storing a program, and the program may be used by or in combination with an instruction execution system, apparatus, or device. The computer-readable signal medium may include a data signal being in a baseband or propagated as at least a part of a carrier wave, and may carry computer-readable program code. The propagated data signal may be in a plurality of forms, including, but not limited to, an electromagnetic signal, an optical signal, or any appropriate combination thereof. The computer-readable signal medium may be any computer-readable medium other than the computer-readable medium. The computer-readable medium may transmit, propagate, or transfer a program that is used by or used in combination with an instruction execution system, apparatus or device. The program code included in the computer-readable medium may be transmitted by using any suitable medium, including but not limited to: a wireless medium, a wired medium, or the like, or any suitable combination thereof.

The flowcharts and block diagrams in the accompanying drawings illustrate system architectures, functions, and operations, according to some embodiments, that may be implemented by a system, a method, and a computer program product. In this regard, each box in the flowchart or the block diagram may represent a module, a program segment, or a part of code. The module, the program segment, or the part of code includes one or more executable instructions configured for implementing specified logic functions. In some implementations used as substitutes, functions marked in boxes may occur in a sequence different from that marked in an accompanying drawing. For example, two boxes shown in succession may be performed in parallel, and sometimes the two boxes may be performed in a reverse sequence. Each block in the block diagram or the flowchart, and a combination of blocks in the block diagram or the flowchart may be implemented by using a dedicated hardware-based system that performs a specified function or operation, or may be implemented by using a combination of dedicated hardware and computer instructions.

Although several modules or units of a device for action execution are mentioned in the foregoing detailed descriptions, the division is not mandatory. The features and functions of two or more modules or units described above may be specified in one module or unit. Conversely, the features and functions of one module or unit described above may be further divided into a plurality of modules or units.

Through the description of the foregoing embodiments, a person skilled in the art can understand that the exemplary implementations described herein may be implemented by software, or may be implemented by combining software with necessary hardware. Therefore, the technical solutions of some embodiments may be implemented in a form of a software product. The software product may be stored in a non-volatile storage medium (which may be a CD-ROM, a USB flash drive, a removable hard disk, or the like) or on a network, including several instructions to cause an electronic device to perform the method according to some embodiments.

The disclosure is not limited to the precise structures described above and shown in the accompanying drawings, and various modifications and changes can be made without departing from the scope of the disclosure.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A terminal positioning method, applied to a vehicle-to-everything terminal, the method comprising:
receiving a PC5 message via a PC5 communication interface; and
based on determining the PC5 message was transmitted by a target road side unit, activating positioning, and
performing positioning in a movement process in different positioning modes based on a current terminal position,
wherein a positioning accuracy of a positioning mode is increased as a distance between the current terminal position and a collision-prone area decreases, and
wherein the positioning accuracy is decreased as the distance between the current terminal position and the collision-prone area increases.

2. The method according to claim 1, wherein a message header of the PC5 message includes identification information, and
wherein the determining the PC5 message comprises:
obtaining the identification information in the message header;
obtaining first position information in the message header based on the identification information being road side unit identification information;
comparing the first position information with second position information of the target road side unit; and
determining that the PC5 message was transmitted by the target road side unit based on the first position information corresponding to the second position information.

3. The method according to claim 1, wherein the collision-prone area is arranged at a center of a signal coverage area of the target road side unit,
wherein the signal coverage area includes a first area and a second area arranged from outside to inside,
wherein the performing positioning comprises:
performing the positioning in a first positioning mode based on the current terminal position being in the first area; and
performing the positioning in a second positioning mode based on the current terminal position being in the second area, and
wherein a first positioning accuracy of the first positioning mode is lower than a second positioning accuracy of the second positioning mode.

4. The method according to claim 3, wherein the method further comprises:
turning off PC5 message transmission based on performing the positioning in the first positioning mode; and
activating the PC5 message transmission and performing first collision warning based on the PC5 message transmission, based on performing the positioning in the second positioning mode.

5. The method according to claim 4, wherein the second positioning mode is a cellular vehicle-to-everything PC5-based global navigation satellite system real-time kinematic (GNSS-RTK) positioning mode, and
wherein the activating the PC5 message transmission and performing first collision warning comprises:
receiving a RTK differential correction signal transmitted by the target road side unit via the PC5 communication interface;
obtaining positioning information based on obtaining initial positioning information and correcting the initial positioning information according to the RTK differential correction signal; and
transmitting the positioning information to a vehicle via the PC5 communication interface to cause the vehicle to perform second collision warning according to the positioning information.

6. The method according to claim 3, wherein the method further comprises:
determining a target positioning mode based on a position relationship between the current terminal position and the second area, based on a movement direction being away from the collision-prone area; and
performing the positioning in the target positioning mode.

7. The method according to claim 6, wherein the determining the target positioning mode comprises:
using the second positioning mode as the target positioning mode based on the current terminal position being in the second area; and
based on the current terminal position being outside the second area,
determining whether the PC5 message is received;
using the first positioning mode as the target positioning mode based on the PC5 message being received; and
stopping the positioning based on the PC5 message not being received.

8. The method according to claim 3, wherein a bandwidth area is arranged between the first area and the second area, and
wherein the method further comprises:
performing the positioning in the second positioning mode based on the current terminal position being in the bandwidth area and a movement direction facing the collision-prone area; and
performing the positioning in the first positioning mode based on the current terminal position being in the bandwidth area and the movement direction being away from the collision-prone area.

9. The method according to claim 1, wherein the method further comprises performing the positioning at different positioning frequencies,
wherein a positioning frequency increases as the distance between the current terminal position and the collision-prone area decreases, and
wherein the positioning frequency decreases as the distance between the current terminal position and the collision-prone area increases.

10. The method according to claim 5, wherein the first positioning mode is a global navigation satellite system (GNSS) positioning mode, and the second positioning mode is the GNSS-RTK positioning mode.

11. A terminal positioning apparatus, configured in a vehicle-to-everything terminal, the apparatus comprising:
a PC5 communication interface;
at least one memory configured to store computer program code; and
at least one processor configured to read the program code and operate as instructed by the program code, the program code comprising:
receiving code configured to cause at least one of the at least one processor to receive a PC5 message via the PC5 communication interface; and
positioning code configured to cause at least one of the at least one processor to:
determine whether the PC5 message was transmitted by a target road side unit; and
based on the PC5 message being transmitted by the target road side unit, activate positioning, and
perform positioning in a movement process in different positioning modes based on a current terminal position,
wherein a positioning accuracy of a positioning mode is increased as a distance between the current terminal position and a collision-prone area decreases, and
wherein the positioning accuracy is decreased as the distance between the current terminal position and the collision-prone area increases.

12. The terminal positioning apparatus according to claim 11, wherein a message header of the PC5 message comprises identification information, and
wherein the positioning code is further configured to cause at least one of the at least one processor to:
obtain the identification information in the message header;
obtain first position information in the message header based on the identification information being road side unit identification information;
compare the first position information with second position information of the target road side unit; and
determine that the PC5 message was transmitted by the target road side unit based on the first position information corresponding to the second position information.

13. The terminal positioning apparatus according to claim 11, wherein the collision-prone area is arranged at a center of a signal coverage area of the target road side unit,
wherein the signal coverage area comprises a first area and a second area arranged from outside to inside,
wherein the positioning code is further configured to cause at least one of the at least one processor to:
perform the positioning in a first positioning mode based on the current terminal position being in the first area; and
perform the positioning in a second positioning mode based on the current terminal position being in the second area, and
wherein a first positioning accuracy of the first positioning mode is lower than a second positioning accuracy of the second positioning mode.

14. The terminal positioning apparatus according to claim 13, wherein the program code further comprises:
turning off code configured to cause at least one of the at least one processor to turn off PC5 message transmission based on the positioning being performed in the first positioning mode; and
activating code configured to cause at least one of the at least one processor to activate the PC5 message transmission and perform first collision warning based on the PC5 message transmission, based on the positioning being performed in the second positioning mode.

15. The terminal positioning apparatus according to claim 14, wherein the second positioning mode is a cellular vehicle-to-everything PC5-based global navigation satellite system real-time kinematic (GNSS-RTK) positioning mode, and
wherein the activating code is further configured to cause at least one of the at least one processor to:
receive a RTK differential correction signal transmitted by the target road side unit via the PC5 communication interface;
obtain positioning information based on obtaining initial positioning information and correcting the initial positioning information according to the RTK differential correction signal; and
transmit the positioning information to a vehicle via the PC5 communication interface to cause the vehicle to perform second collision warning according to the positioning information.

16. The terminal positioning apparatus according to claim 13, wherein the program code further comprises:
target determining code configured to cause at least one of the at least one processor to determine a target positioning mode based on a position relationship between the current terminal position and the second area, based on a movement direction being away from the collision-prone area; and
target performing code configured to cause at least one of the at least one processor to perform the positioning in the target positioning mode.

17. The terminal positioning apparatus according to claim 16, wherein the target determining code is further configured to cause at least one of the at least one processor to:
use the second positioning mode as the target positioning mode based on the current terminal position being in the second area; and
based on the current terminal position being outside the second area,
determine whether the PC5 message is received;
use the first positioning mode as the target positioning mode based on the PC5 message being received; and
stop the positioning based on the PC5 message not being received.

18. The terminal positioning apparatus according to claim 13, wherein a bandwidth area is arranged between the first area and the second area, and
wherein the program code further comprises bandwidth performing code configured to cause at least one of the at least one processor to:
perform the positioning in the second positioning mode based on the current terminal position being in the bandwidth area and a movement direction facing the collision-prone area; and
perform the positioning in the first positioning mode based on the current terminal position being in the bandwidth area and the movement direction being away from the collision-prone area.

19. The terminal positioning apparatus according to claim 11, wherein the program code further comprises frequency performing code configured to cause at least one of the at least one processor to perform positioning at different positioning frequencies,
wherein a positioning frequency increases as the distance between the current terminal position and the collision-prone area decreases, and
wherein the positioning frequency decreases as the distance between the current terminal position and the collision-prone area increases.

20. A non-transitory computer-readable storage medium, storing computer code which, when executed by at least one processor, causes the at least one processor to at least:
receive a PC5 message via a PC5 communication interface;
determine whether the PC5 message was transmitted by a target road side unit; and
based on the PC5 message being transmitted by the target road side unit, activate positioning, and
perform positioning in a movement process in different positioning modes based on a current terminal position.
wherein a positioning accuracy of a positioning mode is increased as a distance between the current terminal position and a collision-prone area decreases, and
wherein the positioning accuracy is decreased as the distance between the current terminal position and the collision-prone area increases.
